(19) United States
(12) Patent Application Publication
(10) Pub. No.: US 2016/0136872 A1
(43) Pub. Date: May 19, 2016

(54) IMPRINT APPARATUS AND METHOD OF MANUFACTURING ARTICLE

(71) Applicant: CANON KABUSHIKI KAISHA, Tokyo (JP)

(72) Inventor: Masakatsu Yanagisawa, Tochigi-shi (JP)

(21) Appl. No.: 14/934,460

(22) Filed: Nov. 6, 2015

(30) Foreign Application Priority Data
Nov. 14, 2014 (JP) 2014-231969

(51) Int. Cl. B29C 59/00; B29C 59/02

(52) U.S. Cl. CPC B29C 59/002; B29C 59/026

(57) ABSTRACT

The present invention provides an imprint apparatus which performs an imprint process of forming a pattern in an imprint material on a substrate using a mold, the apparatus including a measurement unit configured to measure relative positions of the mold and the substrate by detecting a mark provided on each of the mold and the substrate, and a processing unit configured to perform alignment between the mold and the substrate based on a measurement result of the measurement unit, wherein if mark detection by the measurement unit shows an abnormality, the processing unit selects one recovery process from a plurality of recovery processes set in advance and performs the one recovery process in accordance with a time in which it is possible to perform the alignment in the imprint process.

### BACKGROUND OF THE INVENTION

1. Field of the Invention

The present invention relates to an imprint apparatus and a method of manufacturing an article.

2. Description of the Related Art

An imprint technique is a technique capable of transferring a nanoscale fine pattern and is attracting attention as one of nano-lithography techniques. An imprint apparatus using the imprint technique forms a pattern (unevenness) on a substrate by curing a resin (imprint material) on the substrate in a state in which the resin and a mold on which the pattern has been formed are in contact with each other, and separating the mold from the cured resin.

The imprint apparatus implements a variety of resin-curing methods in accordance with an application purpose. However, a photo-curing method of curing the resin on the substrate by irradiation with light such as ultraviolet (UV) light is generally adopted as a technique for volume production of semiconductor devices or the like (see Japanese Patent No. 4185941). The imprint apparatus also adopts a die-by-die alignment method as a method of alignment between the mold and the substrate. The die-by-die alignment method is an alignment method of correcting, for each shot region on the substrate, a shift in the positional relationship between the mold and the substrate by optically detecting a mold-side alignment mark and a substrate-side alignment mark at the same time.

Alignment between the mold and the substrate is performed in a time (period) from bringing the mold and the resin on the substrate into contact with each other to curing the resin on the substrate, that is, a filling time of filling a mold pattern with the resin. The filling time is set so as to increase throughput in consideration of a filling property from resin properties, the mold pattern, or the like.

In the imprint apparatus, however, alignment between the mold and the substrate is not performed normally in the filling time of filling the mold pattern with the resin, and overlay accuracy decreases, bringing about a pattern transfer error (product defect). The cause of abnormal alignment lies in the mixing of a foreign substance between the mold-side alignment mark and the substrate-side alignment mark, the unfilling of the mold pattern with the resin, or the like.

### SUMMARY OF THE INVENTION

The present invention provides an imprint apparatus advantageous in alignment between a mold and a substrate.

According to one aspect of the present invention, there is provided an imprint apparatus which performs an imprint process of forming a pattern in an imprint material on a substrate using a mold, the apparatus including a measurement unit configured to measure relative positions of the mold and the substrate by detecting a mark provided on each of the mold and the substrate, and a processing unit configured to perform alignment between the mold and the substrate based on a measurement result of the measurement unit, wherein if mark detection by the measurement unit shows an abnormality, the processing unit selects one recovery process from a plurality of recovery processes set in advance and performs the one recovery process in accordance with a time in which it is possible to perform the alignment in the imprint process.

Further aspects of the present invention will become apparent from the following description of exemplary embodiments with reference to the attached drawings.

### BRIEF DESCRIPTION OF THE DRAWINGS

FIG. 1 is a schematic view showing the arrangement of an imprint apparatus according to an aspect of the present invention.

FIG. 2 is a schematic view showing an example of the arrangement of a shape correction unit.

FIG. 3 is a flowchart for explaining an imprint process.

FIGS. 4A to 4C are views for explaining each step of an imprint operation.

FIG. 5 is a view for explaining an alignment operation.

FIG. 6 is a view for explaining the alignment operation.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

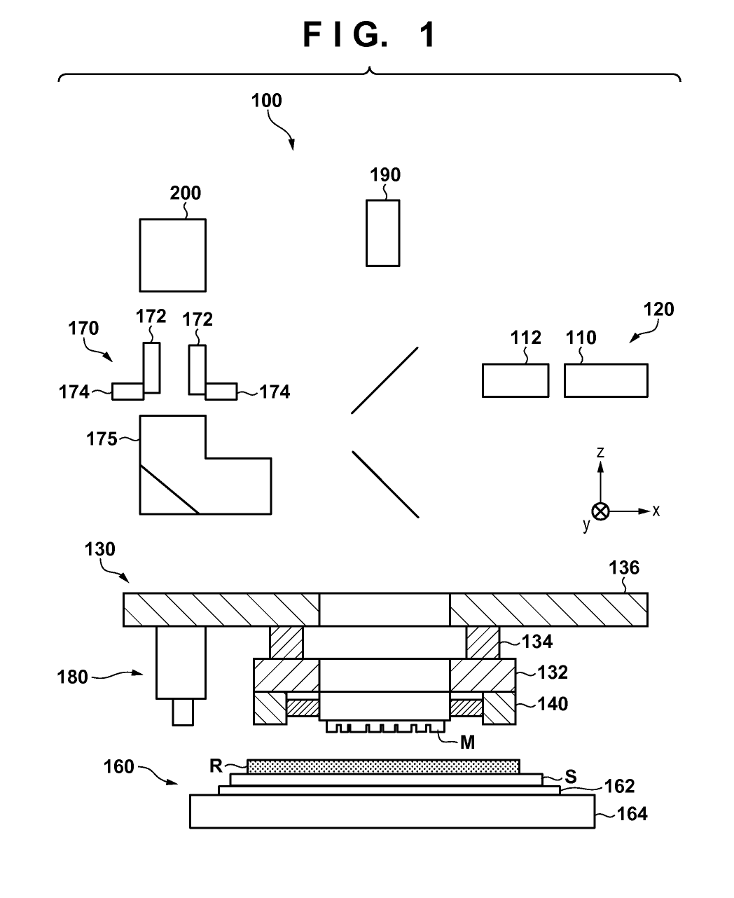

FIG. 1 is a schematic view showing the arrangement of an imprint apparatus 100 according to an aspect of the present invention. The imprint apparatus 100 is a lithography apparatus used in a manufacturing process of a semiconductor device or the like. The imprint apparatus 100 performs an imprint process of forming a pattern in an imprint material on a substrate using a mold. The imprint apparatus 100 forms patterns in a plurality of shot regions on the substrate by repeating imprint processes. Note that one imprint process is a process of forming the pattern in one shot region on the substrate by curing the imprint material on the substrate in a state in which the imprint material and the mold are in contact with each other, and separating (releasing) the mold from the cured imprint material.

In this embodiment, the resin is used as the imprint material and a photo-curing method of curing the resin by irradiation with ultraviolet (UV) light is adopted as a resin-curing method. However, the present invention is not limited to the resin-curing method, and may adopt a thermal curing method of curing the resin by other energy such as heat.

The imprint apparatus 100 includes a curing unit 120, a mold driving unit 130, a shape correction unit 140, a substrate driving unit 160, a measurement unit 170, a resin supply unit 180, an observation unit 190, and a control unit 200. The imprint apparatus 100 also includes a bridge plate configured to hold the mold driving unit 130 and a base plate configured to hold the substrate driving unit 160.

The curing unit 120 includes, for example, a light source unit 110 and an optical system 112. The curing unit 120 irradiates a resin R on the substrate with ultraviolet light via a mold M, thereby curing the resin R. In this embodiment, the resin R is an ultraviolet-curing resin. The light source unit 110 includes a light source such as a halogen lamp which emits ultraviolet light (for example, an i-line or a g-line), and an elliptical mirror which condenses light from the light source. The optical system 112 includes a lens and an aperture configured to irradiate the resin R on the shot regions of a substrate S with ultraviolet light. The optical system 112 may also include an optical integrator configured to illuminate the mold M uniformly. The aperture is used for angle-of-view control for illuminating only the shot region to be an imprint process target, and a peripheral light-shielding control for restricting the irradiation of the substrate S with ultraviolet light beyond its outer shape. Ultraviolet light whose range is defined by the aperture irradiates the resin R on the substrate via the mold M.

The mold driving unit 130 includes, for example, a mold chuck 132 which holds the mold M, a driving mechanism 134 which drives the mold M by driving (moving) the mold chuck 132, and a base 136 which supports the driving mechanism 134. The driving mechanism 134 has a function of controlling the position of the mold M with respect to six axes, and a function of bringing the mold M into contact with the resin R on the substrate or separating the mold M from the cured resin R on the substrate. Note that six axes are an X-axis, a Y-axis, a Z-axis, and rotation axes thereof in an X-Y-Z coordinate system in which it is assumed that the holding surface (a surface on which the mold M is held) of the mold chuck 132 is an X-Y plane and a direction perpendicular to the X-Y plane is the Z-axis.

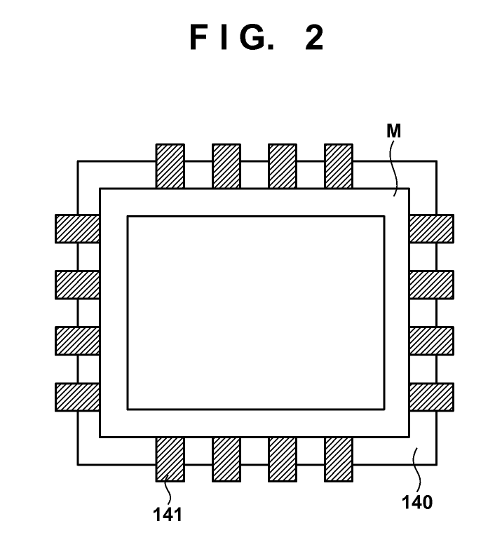

The mold correction unit 140 is arranged in the mold chuck 132. For example, as shown in FIG. 2, the shape correction unit 140 corrects the pattern shape of the mold M by pressurizing the mold M from a peripheral direction using a cylinder which operates by a fluid such as air or oil via a contact unit 141 in contact with the side surfaces of the mold M. Furthermore, the shape correction unit 140 may include a temperature control unit which controls the temperature of the mold M and correct the pattern shape of the mold M by controlling the temperature of the mold M. The substrate S may be deformed (typically, expands or shrinks) after going through a process such as annealing. To cope with such deformation of the substrate S, the shape correction unit 140 corrects the pattern shape of the mold M such that overlay accuracy falls within an allowable range.

The substrate driving unit 160 includes, for example, a substrate chuck 162 which holds (chucks) the substrate S, and a substrate stage 164 which drives the substrate S by driving (moving) the substrate chuck 162. The substrate stage 164 has a function of controlling the position of the substrate S with respect to six axes.

The measurement unit 170 measures the relative positions of the mold M and the substrate S by detecting an alignment mark provided on each of the mold M and the substrate S. The measurement unit 170 includes, for example, alignment scopes 172, scope driving units 174, and an optical system 175. Each alignment scope 172 includes a focus lens, and an Automatic Adjustment Scope (AAS) which performs alignment between the mold M (pattern thereof) and the substrate S (shot regions thereof). Each alignment scope 172 generates an alignment signal by detecting the alignment mark provided on the mold M and the alignment mark provided on the substrate S. Each scope driving unit 174 positions the alignment scope 172 by driving (moving) the alignment scope 172. The optical system 175 includes a lens, an aperture, or a mirror configured to adjust the optical path of each alignment scope 172.

The resin supply unit 180 includes, for example, a tank which accommodates the resin R, a nozzle which discharges the resin R supplied from the tank to the substrate S, a valve provided between the tank and the nozzle, and a supply amount control unit. The supply amount control unit typically controls the valve so as to supply the resin R to one shot region (that is, controls the supply amount of the resin R to the substrate S) in one discharge of the resin R by the nozzle.

The resin supply unit 180 supplies (applies) the resin R onto the substrate in accordance with a map set by the control unit 200. Note that the map indicates the supply position or the supply amount of the droplets of the resin R on the substrate, and is also referred to as a resin dispensing pattern, an imprint recipe, a drop recipe, or the like. The map is determined in consideration of the pattern of the mold M or a residual layer thickness (RLT) used in each imprint process. For example, when increasing the RLT, the map is determined such that the droplets are supplied at high density by shortening the interval between the droplets. Note that the RLT refers to the thickness of the cured resin R between the surface of the substrate S and the surface (bottom surface) of the concave portion of the pattern formed by the resin R.

For example, the observation unit 190 includes a camera and observes the entire shot regions on the substrate S. The observation unit 190 can observe the contact state between the mold M and the resin R on the substrate, the filling state of the pattern of the mold M with the resin R, the separating state of the mold M from the cured resin R on the substrate, and the like.

The control unit 200 includes a CPU and a memory, and controls the overall (respective units) imprint apparatus 100. The control unit 200 controls each imprint process and a process associated with it. For example, the control unit 200 performs alignment between the mold M and the substrate S (functions as a processing unit) based on the measurement result of the measurement unit 170.

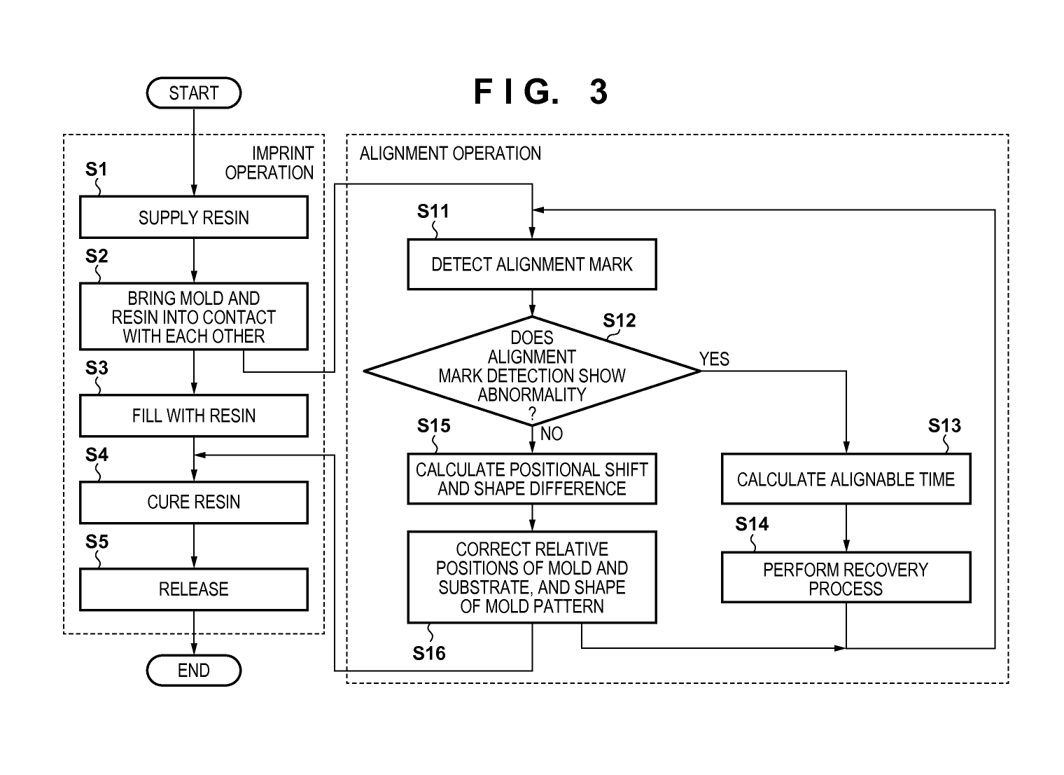

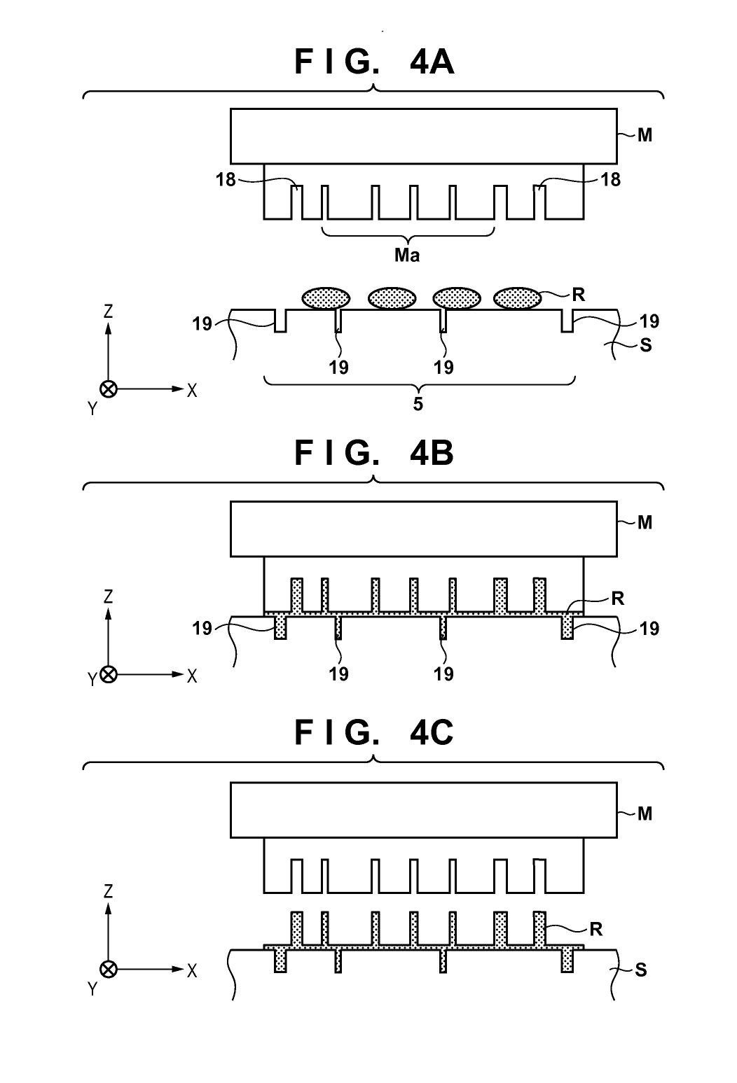

The imprint processes in the imprint apparatus 100 will be described with reference to FIG. 3 and FIGS. 4A to 4C. FIG. 3 is a flowchart for explaining the imprint process. As described above, each imprint process is performed by causing the control unit 200 to generally control the respective units of the imprint apparatus 100. FIG. 3 shows one imprint process, that is, the imprint process for one shot region. Therefore, when forming the pattern in each of the plurality of shot regions on the substrate S, the imprint process shown in FIG. 3 needs to be repeated for each shot region. FIG. 3 shows, in the imprint process, an imprint operation mainly regarding the operation of the mold M for forming the patterns of the resin on the substrate and an alignment operation regarding alignment between the mold M and the substrate S separately. FIGS. 4A to 4C are views for explaining the respective steps of the imprint operation and show a state in which the mold M and the substrate S are viewed from a side surface.

First, the imprint operation will be described. In step S1, the resin R is supplied onto the substrate. More specifically, as shown in FIG. 4A, the resin R is supplied to a shot region 5 of the substrate S using the resin supply unit 180 before bringing the mold M into contact with the resin R. The resin R is generally high in volatility, and thus supplied to the substrate S immediately before imprinting the mold M. If the volatility of the resin is low, the resin may be supplied to the entire surface (the plurality of shot regions) of the substrate S in advance by spin coating. Note that alignment marks 19 are provided in each shot region 5 of the substrate S.

In step S2, the mold M and the resin R on the substrate are brought into contact with each other. More specifically, the substrate stage 164 is driven such that the mold M (a pattern Ma thereof) and the substrate S (the shot region 5 thereof) onto which the resin R has been supplied in step S1 face each other. Once the substrate S and the mold M face each other, the pattern Ma of the mold M and the resin R on the substrate are brought into contact with each other by driving the driving mechanism 134 such that the mold M and the substrate S move closer to one another. If the alignment scopes 172 can detect the alignment marks before the pattern Ma of the mold M and the resin R on the substrate contact each other, alignment between the mold M and the substrate S, that is, the alignment operation can be started.

In step S3, the pattern Ma of the mold M is filled with the resin R. More specifically, as shown in FIG. 4B, the pattern Ma of the mold M is filled with the resin R by maintaining the state in which the mold M and the resin R on the substrate are in contact with each other. At this time, the relative positions of the mold M and the substrate S need to be adjusted, and occurrence of the unfilling of the pattern Ma of the mold M with the resin R when curing the resin R needs to be avoided. To achieve this, a predetermined time (filling time) is ensured to fill the pattern Ma of the mold M with the resin R sufficiently. The unfilling of the pattern Ma of the mold M with the resin R can be reduced by setting the filling time for filling the pattern Ma of the mold M with the resin R appropriately. After bringing the mold M and the resin R on the substrate into contact with each other, alignment between the mold M and the substrate S, that is, the alignment operation is performed continuously so as to correct the positional shift between the mold M and the substrate S which occurs by contact between the mold M and the resin R.

In step S4, the resin R is cured in the state in which the mold M and the resin R on the substrate are in contact with each other. More specifically, the resin R on the substrate is irradiated with ultraviolet light from the curing unit 120 via the mold M. In general, it is considered that the resin R starts to be cured when ultraviolet light from the curing unit 120 reaches the resin R on the substrate. It is therefore possible to regard a timing at which the resin R starts to be cured as a timing at which irradiation with ultraviolet light is started. After starting to cure the resin R on the substrate, alignment between the mold M and the substrate S, that is, the alignment operation which causes pattern damage is not performed. When curing the resin R, since ultraviolet light from the curing unit 120 becomes noise, the alignment scopes 172 cannot detect the alignment marks in spite of their attempt to do so. As a result, it may be impossible to measure the relative positions of the mold M and the substrate S.

In step S5, the mold M is separated (released) from the cured resin R on the substrate. More specifically, as shown in FIG. 4C, the mold M is separated from the cured resin R on the substrate by driving the driving mechanism 134 such that the mold M and the substrate S move away from each other after curing the resin R on the substrate in step S4. However, the mold M may be separated from the cured resin R on the substrate by simultaneously or sequentially driving both the driving mechanism 134 and the substrate stage 164. By doing so, a pattern corresponding to the pattern Ma of the mold M is formed in the resin R on the substrate. Marks corresponding to alignment marks 18 provided on the mold M are also formed in the resin R on the substrate.

Next, the alignment operation will be described. The alignment operation is performed in parallel with a step (step S3) of filling the pattern Ma of the mold M with the resin R in the imprint operation. In the alignment operation, first, the relative positions of the mold M and the substrate S are measured by detecting the alignment marks 18 provided on the mold M and the alignment marks 19 provided on the substrate S. Then, the positional shift and the shape difference between the pattern Ma of the mold M and the shot region 5 of the substrate S are obtained. The relative positions of the pattern Ma and the shot region 5, and the shape of the pattern Ma are corrected such that overlay accuracy falls within the allowable range.

In step S11, the alignment marks 18 provided on the mold M and the alignment marks 19 provided on the substrate S are detected. More specifically, each alignment scope 172 generates the alignment signal by detecting the alignment marks 18 and 19, and obtains the relative positions of the mold M and the substrate S based on the alignment signal. At this time, the number of alignment marks to be a detection target changes depending on the number of alignment scopes 172.

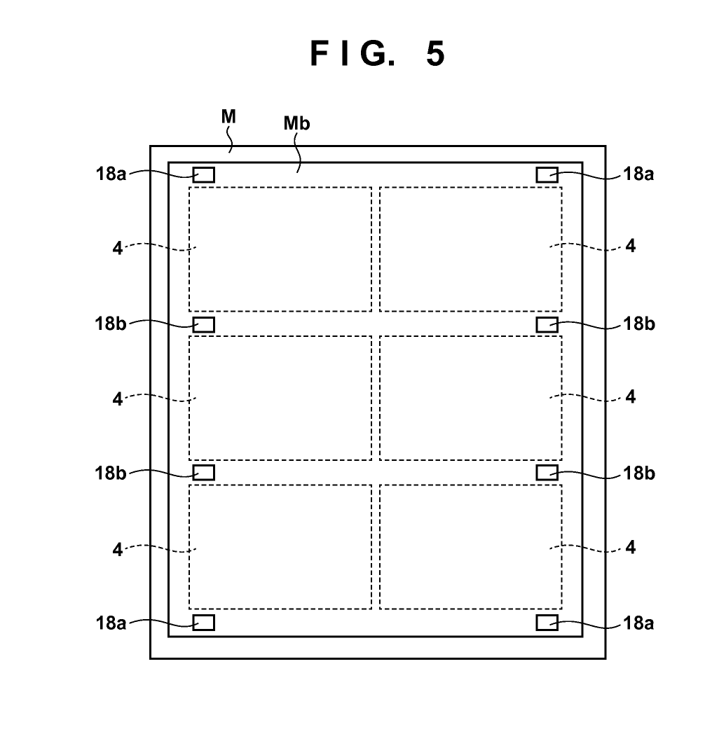

According to this embodiment, in the mold M, alignment marks 18a are provided at the four corners of a pattern surface Mb corresponding to the shot region 5 of the substrate S, as shown in FIG. 5. Furthermore, six chip areas 4 are arranged on the pattern surface Mb of the mold M and each alignment mark 18b is provided between the chip area 4 and the chip area 4. On the other hand, in the substrate S, alignment marks 19a corresponding to the alignment marks 18a are provided at the four corners of the shot region 5. Furthermore, alignment marks 19b corresponding to the alignment marks 18b are provided on the substrate S. The relative positions of the mold M and the substrate S can be measured by detecting the alignment marks 18a and the alignment marks 19a simultaneously in the state in which the mold M and the resin R on the substrate are in contact with each other.

In this embodiment, the alignment marks are provided at the four corners of the pattern surface Mb of the mold M and the four corners of the shot region 5 of the substrate S, and another alignment mark is provided between the chip areas (within a scribe line). However, the present invention is not limited to this. Furthermore, the number of chip areas formed on the pattern surface Mb of the mold M is not limited to six.

Since detection light from each alignment scope 172 transmits the mold M and the resin R, the alignment scope 172 can detect the alignment marks 19a and 19b. On the other hand, if the mold M and the resin R on the substrate contact each other, and the pattern Ma of the mold M is filled with the resin R, it may become impossible to detect the alignment marks 18a and 18b. This is because the refractive index difference between the mold M, and the alignment marks 18a and 18b becomes smaller before and after the mold M and the resin R contact each other. Therefore, a substance different from the mold M in a refractive index or a transmittance may be applied to the alignment marks 18a and 18b, or the refractive index may be changed by ion irradiation or the like. This makes it possible to detect the alignment marks 18a and 18b even in the state in which the mold M and the resin R on the substrate are in contact with each other.

In step S15, the positional shift and the shape difference between the pattern Ma of the mold M and the shot region 5 of the substrate S are calculated based on a detection result in step S11, that is, the relative positions of the mold M and the substrate S obtained in step S11. As the number of alignment marks detected in step S11 increases, it becomes possible to calculate not only a magnification and a rotation error but also a distortion or the like in step S15.

In step S16, the relative positions of the mold M (pattern Ma) and the substrate S (shot region 5), and the shape of the pattern Ma are corrected based on the positional shift and the shape difference calculated in step S15 such that overlay accuracy falls within the allowable range. For example, the relative positions of the mold M and the substrate S are corrected using the substrate driving unit 160, and the shape of the pattern Ma of the mold M is corrected using the shape correction unit 140.

Steps S11, S15, and S16 are repeated after bringing the mold M and the resin R on the substrate into contact with each other until immediately before starting to cure the resin R, gradually reducing the positional shift between the mold M and the substrate S. Then, the alignment operation is stopped after the positional shift between the mold M and the substrate S is reduced sufficiently, and overlay accuracy falls within the allowable range.

However, if alignment mark detection shows an abnormality in step S11, for example, a light amount and a contrast required to obtain the relative positions of the mold M and the substrate S may not be obtained. To cope with this, in this embodiment, after detecting the alignment marks (step S11), it is determined in step S12 whether alignment mark detection shows the abnormality before calculating the positional shift and the shape difference between the pattern Ma of the mold M and the shot region 5 of the substrate S (step S15). The control unit 200 performs this determination. The control unit 200 compares a threshold with the index of each alignment signal generated by detecting the alignment marks in step S11, and determines that alignment mark detection shows the abnormality if the index of the alignment signal does not satisfy the threshold. The index of each alignment signal indicates reliability of alignment mark detection, that is, a requirement needed to obtain the relative positions of the mold M and the substrate S. The index of each alignment signal representatively includes at least one of the intensity, the contrast, and the degree of correlation in pattern matching of the alignment signal. However, the present invention is not limited to this. The threshold used to determine whether alignment mark detection shows the abnormality can be set for each index of the alignment signal and, for example, is stored in a storage unit such as a memory of the control unit 200. Whether alignment mark detection shows the abnormality may be determined by, out of the above-described indices, one index or the combination of the plurality of indices. If alignment mark detection shows the abnormality, the process advances to step S13. On the other hand, if alignment mark detection shows no abnormality, that is, alignment mark detection is normal, the process advances to step S15.

In step S13, a time (alignable time) in which it is possible to perform alignment between the mold M and the substrate S is calculated. As described above, the filling time for filling the pattern Ma of the mold M with the resin R on the substrate is set in advance. It is therefore possible to obtain, as the alignable time, the difference between the filling time and an elapsed time after the mold M and the resin R on the substrate contact each other. Time at which the mold M and the resin R on the substrate contact each other can be obtained from the contact state between the mold M and the resin R on the substrate observed by the observation unit 190. It can also be obtained from an elapsed time after the mold driving unit 130 is driven to bring the mold M and the resin R on the substrate into contact with each other. In this case, however, a time taken from driving the mold driving unit 130 to bringing the mold M and the resin R on the substrate into contact with each other needs to be obtained in advance. It is also possible to obtain the alignable time from the contact state between the mold M and the resin R on the substrate observed by the observation unit 190.

In step S14, a recovery process for detecting the alignment marks normally is performed. More specifically, in accordance with the alignable time calculated in step S13, one recovery process is selected from a plurality of recovery processes set in advance, and then the selected one recovery process is performed. The recovery processes are not particularly limited as long as they are processes for detecting the alignment marks normally, as described above. In this embodiment, the first process, the second process, and the third process below are set in advance as the plurality of recovery processes.

First process: a process of changing the alignment mark to be the measurement target by the measurement unit 170
Second process: a process of changing a focus state when detecting the alignment marks by the measurement unit 170
Third process: a process of changing a detection condition when detecting the alignment marks by the measurement unit 170

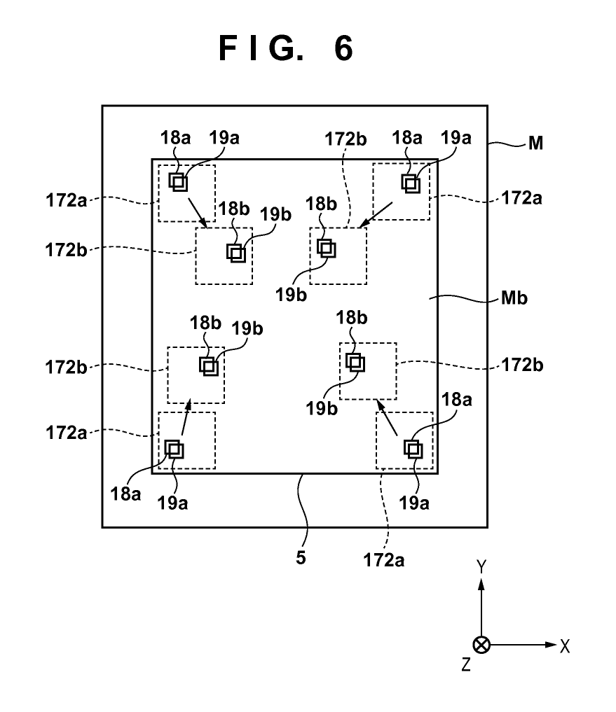

In the first process, the alignment mark to be the measurement target is changed by driving each alignment scope 172 (that is, moving the detection field of the alignment scope) using the scope driving unit 174. For example, as shown in FIG. 6, the detection field of each alignment scope 172 moves from a field 172a to a field 172b by driving the alignment scope 172 in the X and Y directions using the scope driving unit 174. This allows each alignment scope 172 to detect the alignment marks 18b and 19b different from the alignment marks 18a and 19a again. In FIG. 6, the detection fields are moved by driving all the four alignment scopes 172. However, the present invention is not limited to this. It is only necessary to drive at least the alignment scope 172 which has detected the alignment mark that was determined as abnormal in alignment mark detection.

In the second process, the focus state, for example, a best focus position is changed by driving a focus lens included in each alignment scope 172.

In the third process, as the detection condition when detecting the alignment marks, for example, at least one of the light amount of light which illuminates the alignment marks and the wavelength of light which illuminates the alignment marks is changed. However, the present invention is not limited to this.

Even if alignment mark detection shows the abnormality, it may be impossible to specify the cause of that abnormality. In this case, the above-described various recovery processes are performed to detect the alignment marks normally. However, the time in which it is possible to perform alignment between the mold M and the substrate S, that is, the alignable time is limited. In other words, the filling time for filling the pattern Ma of the mold M with the resin R on the substrate is set in advance, and the alignment operation has to be terminated within that filling time. A time that can be spent on the recovery processes is limited depending on a step of repeating the alignment operations. Therefore, the recovery processes need to be performed in accordance with that time.

In this embodiment, one process is selected as the recovery process from the first process, the second process, and the third process in accordance with the alignable time in which it is possible to perform alignment between the mold M and the substrate S. More specifically, if the alignable time is 2 sec or more (first time or more), the first process is selected. If the alignable time is 1 sec or more (second time or more) but less than 2 sec (less than the first time), the second process is selected. If the alignable time is less than 1 sec (less than the second time), the third process is selected. Note that the relationship between the alignable time and the recovery process to be selected (the setting of the first time, the second time, and the like) is merely an example, and is set appropriately for each recipe of the imprint processes.

Note that a portion between the alignment marks 18 and the alignment marks 19 may not be filled with the resin R depending on a process of filling the pattern Ma of the mold M with the resin R. This may make it impossible to detect the alignment marks 18 and 19. In this case, the alignment marks 18 and 19 may be detected again (step S11) without performing the recovery process (step S14). More specifically, if the alignable time is 3 sec or more, it is considered that the portion between the alignment marks 18 and the alignment marks 19 is not filled with the resin R, and the alignment marks 18 and 19 are detected again without performing the recovery process. As a result of performing detection again, it may be considered that alignment mark detection shows the abnormality. In this case, if the alignable time is from 2 sec (inclusive) to 3 sec (exclusive), the first process can be selected.

As described above, in the alignment operation of this embodiment, if alignment mark detection shows the abnormality, the recovery process for detecting the alignment marks normally is performed in accordance with the alignable time in which it is possible to perform alignment between the mold M and the substrate S. It is therefore possible to terminate the alignment operation within the filling time of filling the pattern Ma of the mold M with the resin R.

In this embodiment, if alignment mark detection shows the abnormality, calculation (step S15) and correction (step S16) of the positional shift and the shape difference between the pattern Ma of the mold M and the shot region 5 of the substrate S using the detection result are not performed. This makes it possible to avoid the wrong alignment operation and reduce a time required for the alignment operation.

The recovery process performed in step S14 can be informed to a user via an informing unit such as a console screen of the imprint apparatus 100. The informing unit can inform the user of not only the recovery process but also the result of alignment mark detection performed in step S11 and the result of determination in step S12 of whether alignment mark detection shows the abnormality performed. These pieces of information will be referred to in a post-process such as a detection process and will be advantageous in quality management.

Since the alignment operation is performed in parallel to step (step S3) of filling the pattern Ma of the mold M with the resin R, it is also considered that the filling time is extended when performing the recovery process. It is known, however, that the extension of the filling time influences the residual layer thickness of the resin R. The filling time needs to be controlled appropriately so as to obtain the desired residual layer thickness of the resin R. It is therefore necessary to extend the filling time without exceeding an allowable range.

In the imprint apparatus 100, the alignment operation can be terminated normally within the filling time of filling the pattern Ma of the mold M with the resin R. It is therefore possible to reduce a pattern transfer error (product defect) by suppressing a decrease in overlay accuracy. Hence, the imprint apparatus 100 can economically provide an article such as a high-quality semiconductor device with high throughput.

A method of manufacturing a device (the semiconductor device, a magnetic storage media, a liquid crystal display element, or the like) serving as the article will be described. The manufacturing method includes a step of forming the pattern on the substrate (a wafer, a glass plate, a film-like substrate, or the like) using the imprint apparatus 100. The manufacturing method further includes a step of processing the substrate on which the pattern has been formed. The processing step can include a step of removing the residual film of the pattern. The processing step can also include another known step such as a step of etching the substrate using the pattern as a mask. The method of manufacturing the article according to this embodiment is advantageous in at least one of the performance, the quality, the productivity, and the production cost of the article, as compared to conventional methods.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-231969 filed on Nov. 14, 2014, which is hereby incorporated by reference herein in its entirety.

What is claimed is:

1. An imprint apparatus which performs an imprint process of forming a pattern in an imprint material on a substrate using a mold, the apparatus comprising:
a measurement unit configured to measure relative positions of the mold and the substrate by detecting a mark provided on each of the mold and the substrate; and
a processing unit configured to perform alignment between the mold and the substrate based on a measurement result of the measurement unit,
wherein if mark detection by the measurement unit shows an abnormality, the processing unit selects one recovery process from a plurality of recovery processes set in advance and performs the one recovery process in accordance with a time in which it is possible to perform the alignment in the imprint process.

2. The apparatus according to claim 1, wherein a filling time for filling the pattern of the mold with the imprint material is set in advance, and
the processing unit obtains, as the time in which it is possible to perform the alignment, a difference between the filling time and an elapsed time after the mold and the imprint material contact each other.

3. The apparatus according to claim 1, further comprising an observation unit configured to observe a contact state between the mold and the imprint material,
wherein the processing unit obtains the time in which it is possible to perform the alignment based on the contact state observed by the observation unit.

4. The apparatus according to claim 1, wherein the plurality of recovery processes include a first process of changing a mark to be a measurement target by the measurement unit, a second process of changing a focus state when detecting the mark by the measurement unit, and a third process of changing a detection condition when detecting the mark by the measurement unit.

5. The apparatus according to claim 4, further comprising a driving unit configured to drive the measurement unit,
wherein in the first process, the mark to be the measurement target is changed by driving the measurement unit using the driving unit.

6. The apparatus according to claim 4, wherein the measurement unit includes a focus lens, and
in the second process, the focus state is changed by driving the focus lens.

7. The apparatus according to claim 4, wherein the detection condition includes at least one of a light amount of light which illuminates the mark and a wavelength of light which illuminates the mark.

8. The apparatus according to claim 4, wherein the processing unit
selects the first process from the plurality of recovery processes if the time in which it is possible to perform the alignment is not less than a first time,
selects the second process from the plurality of recovery processes if the time in which it is possible to perform the alignment is from a second time (inclusive) to the first time (exclusive), and
selects the third process from the plurality of recovery processes if the time in which it is possible to perform the alignment is less than the second time.

9. The apparatus according to claim 8, wherein the first time and the second time are set for each recipe of the imprint process.

10. The apparatus according to claim 1, wherein the measurement unit generates an alignment signal by detecting the mark, and
the processing unit determines that mark detection by the measurement unit shows the abnormality if an index of the alignment signal generated by the measurement unit does not satisfy a threshold.

11. The apparatus according to claim 10, wherein the index includes at least one of an intensity, a contrast, and a degree of correlation in pattern matching of the alignment signal.

12. The apparatus according to claim 1, further comprising an informing unit configured to inform the recovery process performed by the processing unit.

13. A method of manufacturing an article, the method comprising:
forming a pattern on a substrate using an imprint apparatus; and
processing the substrate on which the pattern has been formed,
wherein the imprint apparatus performs an imprint process of forming a pattern in an imprint material on the substrate using a mold, and includes:
a measurement unit configured to measure relative positions of the mold and the substrate by detecting a mark provided on each of the mold and the substrate; and
a processing unit configured to perform alignment between the mold and the substrate based on a measurement result of the measurement unit,
wherein if mark detection by the measurement unit shows an abnormality, the processing unit selects one recovery process from a plurality of recovery processes set in advance and performs the one recovery process in accordance with a time in which it is possible to perform the alignment in the imprint process.
